(19) United States
(12) Patent Application Publication
(10) Pub. No.: US 2006/0104682 A1
(43) Pub. Date: May 18, 2006

(54) Image recording apparatus and image reading apparatus

(75) Inventor: Yohichi Shimazawa, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/270,233

(22) Filed: Nov. 8, 2005

(30) Foreign Application Priority Data
Nov. 12, 2004 (JP) 2004-329485

(51) Int. Cl. G03G 21/00

(52) U.S. Cl. 399/366

(57) ABSTRACT

An image recording apparatus which accepts image data and records an image based on thus accepted image data on a sheet comprises storage means which stores predetermined patterns and means which records the patterns outside a recording area for the image, during recording of the image on the sheet.

### CROSS-REFERENCE TO RELATED APPLICATIONS

This Nonprovisional application claims priority under 35 U.S.C §119(a) on Patent Application No. 2004-329485 filed in Japan on Nov. 12, 2004, the entire contents of which are hereby incorporated by reference.

### BACKGROUND OF THE INVENTION

1. Field of the Invention

The present invention relates to an image recording apparatus comprising means which records a pattern with which the source of a printed matter is identified and to an and image reader apparatus.

2. Description of Related Art

Recent improved capabilities of image recording apparatuses such as digital color copiers and digital multi-function machines have raised the importance of anti-copy techniques for confidential document, paper money, marketable securities, etc. Anti-copy techniques implemented in conventional image recording apparatuses, in an attempt to prevent copying of an original copy, require determining based on image data obtained by reading an image recorded on a recording paper such a document, at the time of producing a copy-protected document, and upon detection of the target image, copying is prohibited or a different image than the image read earlier is recorded.

To this end, such an image processing apparatus has been proposed (e.g., U.S. Pat. No. 2,614,369) which records, at the time of producing a copy-protected document, a specific pattern indicative of identification information unique to the apparatus together with an image of an original copy and determines whether to permit copying is determined in accordance with whether this pattern is detected at the time of copying.

However, since the method described in this patent demands recording somewhere on a sheet of paper a specific pattern indicative of identification information unique to the apparatus, there is a problem that the image quality deteriorates, and depending upon a background image, the accuracy of detection worsens. In addition, since the recording position of the specific pattern is not necessarily a predetermined position on a sheet, analysis of the read image as a whole is necessary for detection of the specific pattern, which makes it impossible to shorten the detection time.

### BRIEF SUMMARY OF THE INVENTION

The present invention has been made in light of the circumstance above, and accordingly aims at providing an image recording apparatus which is capable of quickly and securely recording a detected pattern upon reading of an image with an image reader apparatus and providing such an image reading apparatus.

The image recording apparatus according to the present invention is an image recording apparatus which accepts image data and records an image based on thus accepted image data on a sheet, and the image recording apparatus comprises storage means which stores predetermined patterns and means which records the patterns outside a recording area for the image, during recording of the image on the sheet.

According to the present invention, since the plural predetermined patterns are recorded outside the recording area for the image while the image is being recorded based on the accepted image data, the patterns will never be recorded over the image which a user has prepared, which prevents a deterioration of the image quality. Further, in the event that an image reader apparatus such as a scanner apparatus reads a printed matter which bears recorded patterns, it is the patterns that are detected first, and hence, the speed of detection improves and a possibility of erroneous detection decreases.

The image recording apparatus according to the present invention is characterized in that the storage means stores a plurality of different patterns, and the image recording apparatus further comprises means which selects, in pattern recording on the sheet, one of the patterns which are stored in the storage means and means which records the pattern selected by this means together with the image on the sheet.

According to the present invention, since the multiple types of patterns are stored and one of the patterns is selected at the time of pattern recording and then recorded on the sheet, different patterns can be added depending upon a user and the date of use.

The image recording apparatus according to the present invention is characterized in comprising means which stores user-related information in association with each pattern and means which accepts the user-related information when the image data are accepted, and a pattern which is stored and associated with the accepted information is selected.

According to the present invention, since user-related information is received at the time of accepting image data and a pattern which is stored in association with the accepted information is selected, the pattern determined for each user is added.

The image recording apparatus according to the present invention is characterized in comprising means which accepts user-related information from outside and means which authenticates a user based on thus accepted information, and upon authentication of a user by this means, recording of the patterns on the sheet is canceled.

According to the present invention, user authentication is executed based on user-related information, and when a user is authenticated, recording of the patterns is canceled, and hence, it is possible to distinguish a printed matter created by a pre-registered user from a printed matter created by an unregistered user.

The image recording apparatus according to the present invention is characterized in comprising means which accepts information from outside and means which generates a pattern based on thus accepted information, and thus generated pattern is recorded together with the image on the sheet.

According to the present invention, since a pattern is generated based on the information accepted from outside and the generated pattern is recorded on a sheet, different patterns can be added depending upon a user and the date of use.

The image recording apparatus according to the present invention is characterized in that the pattern is formed by plural dots and a relationship between the positions of the dots is determined in advance.

According to the present invention, since a pattern to be recorded is formed by the plural dots and the relationship between the positions of the dots is determined in advance, it is possible to detect the feature of the pattern by examining the relationship between the positions of the dots and it is easy to detect the pattern.

The image recording apparatus according to the present invention is characterized in that the patterns are recorded on a sheet such that the patterns surround the image.

According to the present invention, since the patterns are recorded on a sheet such that the patterns surround the image, it is possible to limit an area which should be kept confidential.

The image recording apparatus according to the present invention is characterized in that the sheet is rectangular and each of the patterns are recorded each near each one of the four sides or on each one of the four corners of the sheet.

According to the present invention, since each of the patterns is recorded near each one of the four sides or on each one of the four corners of the sheet, in copying of a printed matter which bears the patterns, it is the patterns that are detected first before detection of the content of the original copy, and therefore, reading of the original copy may be stopped or a warning may be provided upon detection to thereby prevent copying.

The image recording apparatus according to the present invention is characterized in comprising means which reads an image recorded on the sheet, means which records thus read image on the sheet, means which detects whether the image contains the patterns, and means which prohibits recording of the image on the sheet upon detection of the patterns contained in the image.

According to the present invention, unauthorized copying is prevented since whether the image which has been read contains the predetermined patterns is detected and upon detection of the patterns, recording of the image is prohibited.

The image recording apparatus according to the present invention is characterized in comprising means which reads an image recorded on the sheet, means which detects the existence of the patterns while the image is being read and means which stops reading of the image upon detection of the existence of the patterns during reading of the image.

According to the present invention, unauthorized copying is prevented since whether the predetermined patterns exist is detected while the image is being read and upon detection of the patterns, reading of the image is stopped.

The image recording apparatus according to the present invention is characterized in comprising means which reads the image which the image recording apparatus according to any one of the inventions above has recorded on the sheet, means which detects the existence of the predetermined patterns while the image is being read and means which stops reading of the image upon detection of the existence of the patterns during reading of the image.

According to the present invention, unauthorized copying is prevented since whether the predetermined patterns exist is detected while the image is being read and upon detection of the patterns, reading of the image is stopped.

According to the present invention, at the time of recording of an image based on accepted image data, plural predetermined patterns are recorded outside the recording area for this image. Hence, the patterns will never be recorded over the image which a user has prepared, which prevents a deterioration of the image quality. Further, in the event that an image reader apparatus such as a scanner apparatus reads a printed matter which bears the recorded patterns, it is the patterns that are detected first, and hence, the speed of detection improves and erroneous detection is discouraged.

According to the present invention, the multiple types of patterns are stored and one of the patterns is selected at the time of pattern recording and then recorded on a sheet. Hence, a different pattern can be added depending upon a user and the date of use.

According to the present invention, user-related information is received at the time of accepting image data and a pattern which is stored in association with the accepted information is selected. Hence, the patterns determined for each user is added.

According to the present invention, user authentication is executed based on user-related information, and when a user is authenticated, pattern recording is canceled. Hence, it is possible to distinguish a printed matter created by a pre-registered user from a printed matter created by an unregistered user.

According to the present invention, since the pattern is generated based on information received from outside and the generated pattern is recorded on a sheet, a different pattern can be added depending upon a user and the date of use.

According to the present invention, the pattern to be recorded is formed by the plural dots and the relationship between the positions of the dots is determined in advance. Hence, it is possible to detect the feature of the pattern by examining the relationship between the positions of the dots and it is easy to detect the pattern.

According to the present invention, the patterns are recorded on the sheet such that the patterns surround the image. Hence, it is possible to limit an area which should be kept confidential.

According to the present invention, each of the patterns are recorded each near each one of the four sides or on each one of the four corners of the sheet. Hence, in creation of a copy from a printed matter which bears the patterns, it is the patterns that are first detected before detection of the content of the original copy, and therefore, reading of the original copy may be stopped or a warning may be provided upon detection, which enhances the effect of preventing copying.

According to the present invention, whether the image which has been read contains the predetermined patterns is detected and upon detection of the patterns, recording of the image is prohibited. This prevents unauthorized copying.

According to the present invention, whether the predetermined patterns exist is detected while the image is being read and upon detection of the patterns, reading of the image is stopped. This prevents unauthorized copying.

According to the present invention, whether the predetermined patterns exist is detected while the image is being read and upon detection of one of the patterns, reading of the image is stopped. This prevents unauthorized reading of the image.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic explanatory diagram for describing operations in the image recording apparatus according to the present invention;

FIGS. 2A and 2B are schematic diagrams of a recording position for a specific pattern and the structure of the specific pattern;

FIGS. 3A and 3B are explanatory diagrams for describing a state in which a sheet bearing specific patterns is read;

FIG. 4 is a cross sectional view showing the internal structure of the image recording apparatus;

FIG. 5 is a block diagram showing the structure of a control system of the image recording apparatus;

FIG. 6 is a block diagram showing the internal structure of a specific-pattern-synthesis section;

FIG. 7 is a flowchart for explaining a processing sequence which the image recording apparatus follows in copying an original copy;

FIG. 8 is a schematic view showing an example of a screen which appears on a display section of an operation panel;

FIGS. 9A to 9D are schematic diagrams showing other styles in which specific patterns are recorded;

FIGS. 10A and 10B are schematic diagrams showing still other styles in which specific patterns are recorded;

FIG. 11 is a flowchart for describing a processing sequence which the image recording apparatus follows in copying an original copy;

FIG. 12 is a schematic view showing an example of a screen which appears on the display section of the operation panel;

FIG. 13 is a block diagram showing the internal structure of a specific-pattern-synthesis section according to this embodiment;

FIGS. 14A and 14B are flowcharts for describing a processing sequence which the image recording apparatus follows in copying an original copy;

FIG. 15 is a conceptual diagram showing one example of a history control table;

FIGS. 16A and 16B are flowcharts for describing a processing sequence which the image recording apparatus follows in copying an original copy;

FIG. 17 is a block diagram showing the internal structure of a specific-pattern-synthesis section according to this embodiment; and

FIG. 18 is a flowchart for describing a processing sequence which the image recording apparatus follows in copying an original copy.

### DETAILED DESCRIPTION OF THE INVENTION

The present invention will now be described specifically with reference to the associated drawings which illustrate embodiments of the invention.

### FIRST EMBODIMENT

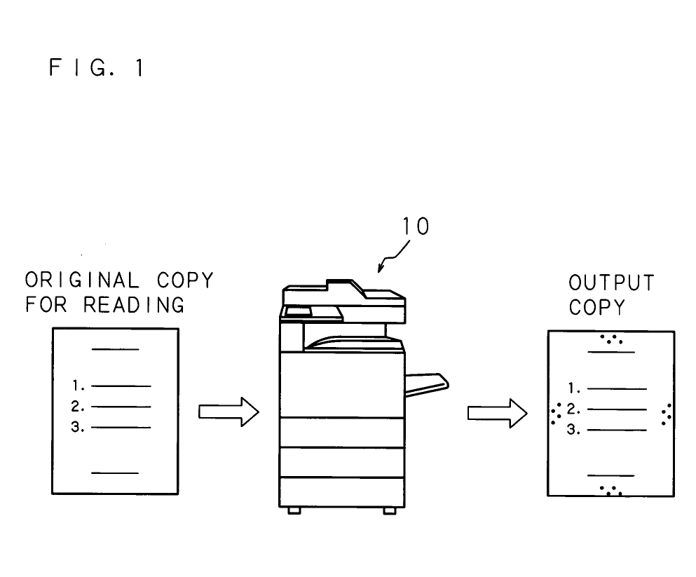

FIG. 1 is a schematic explanatory diagram for describing operations in the image recording apparatus according to the present invention. To be more specific, the image recording apparatus 10 according to the present invention is a copier or digital multi-function machine and equipped with a scanner function of optically reading an image of an original copy and a printer function of recording an image on a sheet such as a general sheet of paper and an overhead projector sheet based on input image data. When commanded to read an image of an original copy and record the read image on a sheet, namely, for copying of the original copy, the image recording apparatus 10 adds a pattern prepared in advance. The pattern which the image recording apparatus 10 adds is a letter, graphic image or symbol which contains information unique to the apparatus or an image combining these, and detection or analysis of the added pattern realizes identification of the origin of the copy. A pattern that is added on a paper by the image recording apparatus 10 will be hereinafter referred to as a specific pattern.

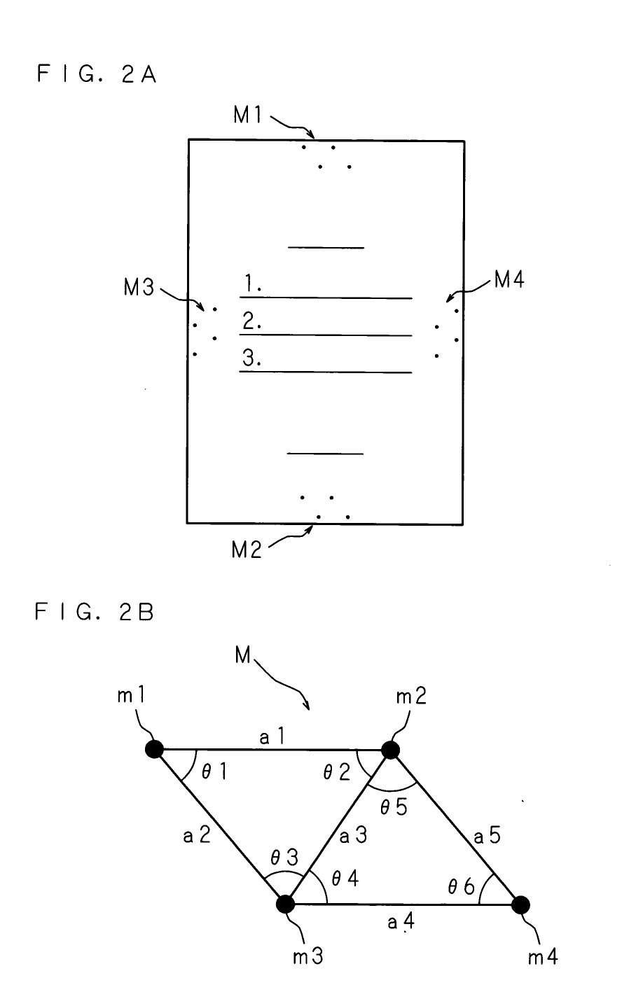

FIGS. 2A and 2B are schematic diagrams which show a recording position for a specific pattern and the structure of the specific pattern. One feature of this embodiment is that a specific pattern is recorded on the outside of a recording region of the image of a original copy, particularly along the four sides of a sheet. In the example in FIG. 2A, there is a specific pattern M1 approximately at the center in an upper end section of the sheet, there is a specific pattern M2 approximately at the center in a lower end section, there is a specific pattern M3 approximately at the center in a left end section, and there is a specific pattern M4 approximately at the center in a right end section. The specific patterns M1 and M2 have the same shape although placed in different orientations, and the specific patterns M3 and M4 have the same shape although placed in different orientations. Unless these need be distinguished, these will be hereinafter referred to merely as specific patterns M.

A specific pattern M is composed of four dots m1 to m4 which have an appropriate size. The dots m1 to m4 forming the specific pattern M are located at the vertices of a rectangle as shown in FIG. 2B. As distances a1 to a5 (among which the distance a1 for example represents the distance between the dot m1 and the dot m2) and angles θ1 to θ6 (among which the angle θ1 for example represents the angle between a segment m1m2 and a segment m1m3) are set as values unique to the apparatus, the specific pattern M contains information unique to the apparatus. In short, for detection or analysis of the specific pattern M, it is possible to find the origin of the copy which bears the specific pattern M from the relationship between the positions of the dots m1 through m4.

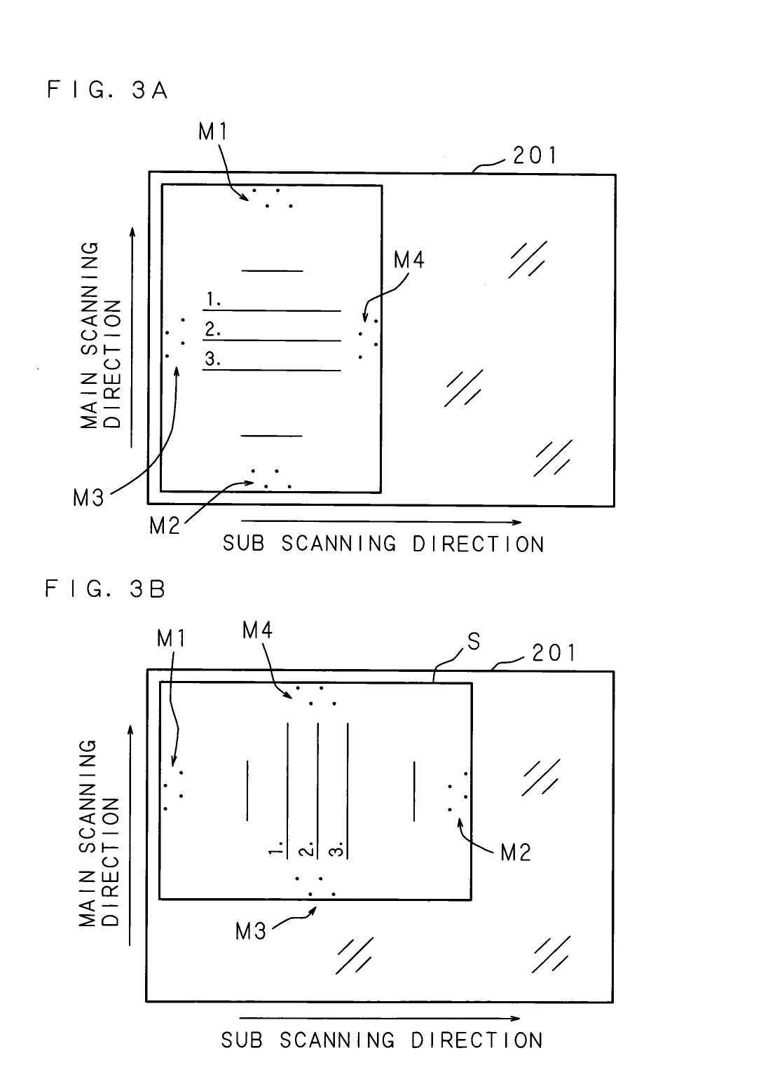

FIGS. 3A and 3B are explanatory diagrams for describing a state in which a sheet bearing the specific pattern M is read. As described later, an image reading section 20 reads an image of an original copy is set on a document mounting 201 of glass, using a CCD reader unit 225 which comprises a CCD line sensor in which a great number of CCDs (Charge Coupled Devices) are lined up along a main scanning direction. Hence, regardless of the direction in which an original copy is placed on the document mounting 201, it is possible to detect one of the specific patterns M1 to M4 before reading an image of the original copy. In the event that an original copy is set parallel to the main scanning direction as shown in FIG. 3A for instance for image reading during scanning of the original copy along a sub scanning direction, the specific pattern M3 is detected before an image of the original copy is read. In a similar manner, when the original copy is positioned vertical with respect to the main scanning direction as shown in FIG. 3B for example for image reading during scanning of the original copy along the sub scanning direction, the specific pattern M1 is detected before the image of the original copy is read. At the time of detection of these specific patterns therefore, the image reading is stopped or a warning is issued, which prevents unauthorized copying.

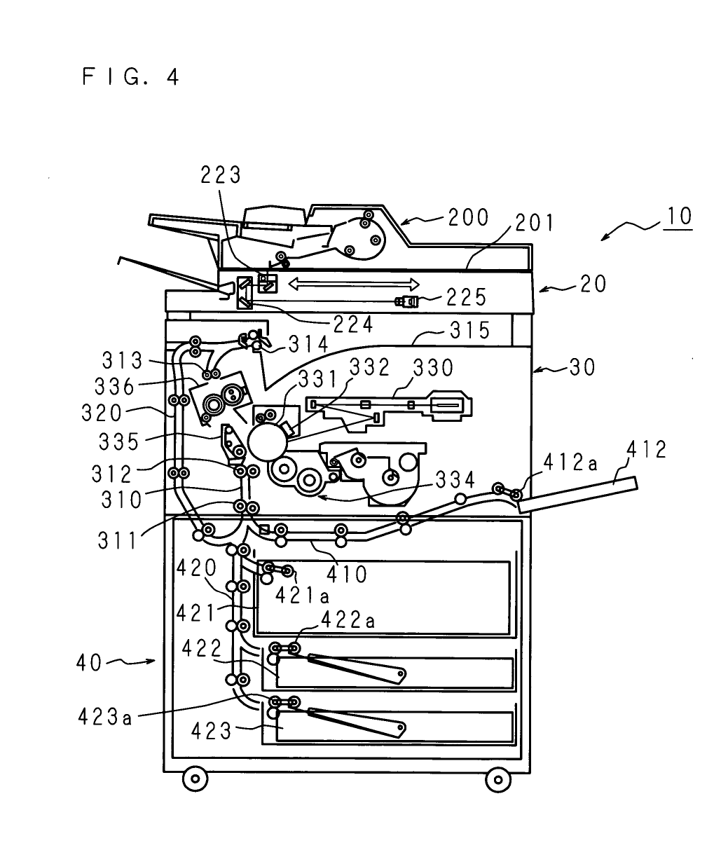

FIG. 4 is a cross sectional view showing the internal structure of the image recording apparatus 10. The image recording apparatus 10 according to the invention is composed generally of the image reading section 20, an image recording section 30 and a paper feeder section 40. The image recording apparatus 10 optically reads with its image reading section 20 an image of an original copy, and with its image recording section 30 records an image on a sheet based on the read image. At this stage, the image recording apparatus 10 records the specific patterns M described above at predetermined positions on the sheet.

The structures of the image reading section 20, the image recording section 30 and the paper feeder section 40 will now be described. The image reading section 20 comprises a light source unit 223, a mirror unit 224 and the CCD reader unit 225. As the light source unit 223 and the mirror unit 224 scan in the direction denoted at the white arrow in FIG. 4, the image reading section 20 reads with its the CCD reader unit 225 an image of an original copy which is set on the document mounting 201 of glass.

The light source unit 223 comprises a light source which irradiates reading irradiation light upon the document mounting 201, a mirror on the like which is disposed with its reflection surface inclined at 45 degrees with respect to a mount surface of the document mounting 201 for the purpose of changing the optical path of reflected light from an original copy by 90 degrees, etc. Driven by a stepping motor not shown, the light source unit 223 moves parallel to the mount surface of the document mounting 201 and irradiates irradiation light upon the entire surface or a selected area of the original copy which is set on the document mounting 201. The mirror unit 224 is composed of paired mirrors which are disposed such that their reflection surfaces are orthogonal to each other, and changes the optical path of light reflected by the mirror of the light source unit 223 further by 180 degrees.

The CCD reader unit 225 comprises a CCD line sensor, an AD converter, a DSP (Digital Signal Processor), etc. An imaging lens located in the middle of a path from the mirror unit 224 to the CCD reader unit 225 focuses the image of the original copy on the CCD line sensor, and the AD converter converts an analog signal obtained by the CCD line sensor into a digital signal. The DSP corrects the light distribution characteristic of the light source during reading of the original copy, the unevenness of the sensitivity of the CCD line sensor, and the like with respect to the digital signal obtained through the AD conversion, whereby digital image data are obtained.

The image reading section 20 further comprises an automatic original copy feeder apparatus 200 which supplies and feeds plural original copies one by one so that it is possible to quickly read many original copies.

The image recording section 30 performs for electrophotographic recording of an image on a paper and comprises a charger unit 332 which charges up a photosensitive drum 331 to a predetermined electric potential, a laser writing unit 330 which emits laser light based on image data obtained with the image reading section 20 and generates an electrostatic latent image on the photosensitive drum 331, a developer unit 334 which supplies toner to and accordingly visualizes the electrostatic latent image generated on the surface of the photosensitive drum 331, a transfer unit 335 which transfers a toner image generated on the surface of the photosensitive drum 331 onto a paper, etc.

The paper feeder section 40 comprises paper feed cassettes 421, 422 and 423 which contains papers of multiple types which are different in terms of sizes, directions and the like, and a hand feed tray 412 which is for accepting a sheet which a user has set. The paper feed cassettes 421, 422 and 423 comprise pick-up rollers 421a, 422a and 423a respectively which are disposed in the vicinity of the front ends of contained sheets, and sheets separated one by one by the pick-up rollers 421a, 422a and 423a are transported to the image recording section 30 on a paper transportation path 420. As for a sheet set in the hand feed tray 412, the structure is similar in that a pick-up rollers 412a located near the front end of the housed sheet takes the sheet into the image recording apparatus 10 and the sheet is transported to the image recording section 30 on a paper transportation path 410.

Operations during recording of an image with the image recording apparatus 10 will now be described. A transportation roller 311 takes a sheet fed by the paper feeder section 40 into inside the image recording section 30, and the sheet is transported to a registration roller 312 on a transportation path 310. There is a pre-registration sensing switch not shown disposed in the vicinity of the registration roller 312, and after temporarily held by the registration roller 312, the sheet which has been fed for alignment with the position of the toner image on the photosensitive drum 331 is transported to a position opposed against the photosensitive drum 331 at predetermined timing. The transfer unit 335 transfers the toner image on the photosensitive drum 331 onto the paper transported to the position opposed against the photosensitive drum 331.

The paper onto which the toner image has been transferred is transported toward a fixing unit 336 which comprises paired fixing rollers, and by heat supplied by the fixing roller, the toner image transferred onto the sheet is fixed. A transportation roller 313 transports the sheet now seating the fixed toner image to the position of a paper discharge roller 314 which then temporarily holds the sheet.

For double-side printing on the sheet, the sheet held by the paper discharge roller 314 is transported again to the registration roller 312 on a double-side original transportation path 320 and an image is recorded on the back side of the transported paper. Where image recording on the both sides of a sheet is not desired or upon transportation of a sheet whose both sides bear recorded images, the sheet is ejected to an output tray 315 via the paper ejection roller 314.

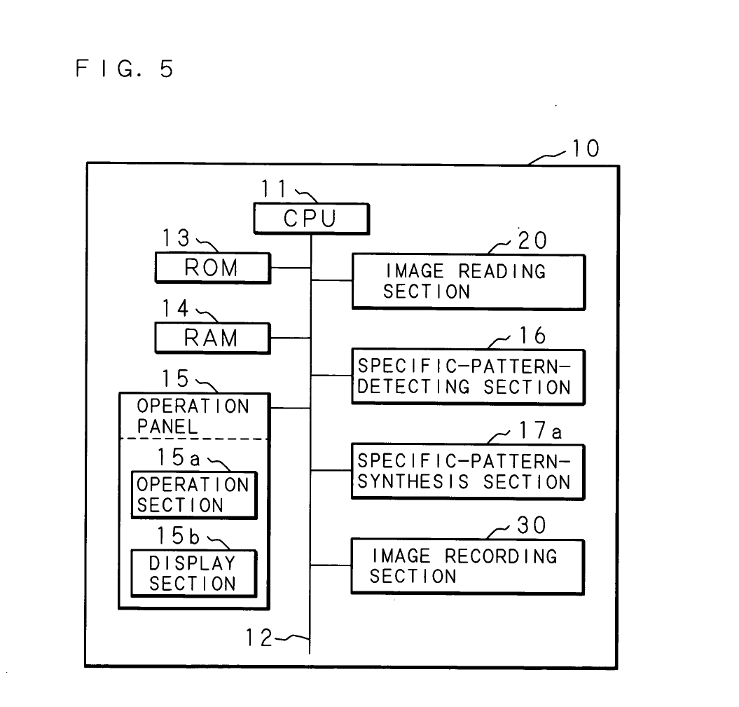

FIG. 5 is a block diagram showing the structure of a control system of the image recording apparatus 10. The image recording apparatus 10 comprises a CPU 11 which loads in a control program pre-stored in a ROM 13 into a RAM 14 and executes the control program, thereby controlling the various types of hardware such as the image reading section 20 and the image recording section 30 which are connected with a bus 12 and making them operate as the image recording apparatus according to the present invention.

The various types of hardware connected with the bus 12 will now be described. An operation panel 15 is composed of an operation section 15a which accepts operation instructions from a user and a display section 15b which displays information which need be brought to the user's attention. The operation section 15a comprises various types of hardware keys so as to accept settings with respect to switching between functions, the number of prints to make and the density of a image recorded. The display section 15b comprises a liquid crystal or a LED display or the like and displays the operation status of the image recording apparatus 10, setting values given by the operation section 15a, etc. Included as a part of the display section 15b is touch-panel software keys which allow a user make selections.

Connected with the bus 12 via an interface circuit not shown, the image reading section 20 receives an instruction from the CPU 11 through the interface circuit and executes an image reading operation in accordance with the instruction. Further, the image reading section 20 sends various data to and receives various data from the respective hardware sections via the interface circuit. In the event that reading of an original copy is demanded through the operation panel 15 for example, the CPU 11 instructs the light source unit 223 and the mirror unit 224 instructs to start reading the original copy via the interface circuit. The light source unit 223 receiving the instruction turns on the light source and the stepping motor (not shown), which is a drive source for the light source unit 223 and the mirror unit 224, is driven to read an image existing within the range instructed by the order, whereby the original copy is scanned. The image of the original copy is read, and image data acquired by the CCD reader unit 225 are transferred to a predetermined destination.

A specific-pattern-detecting section 16 detects whether the image data read by the image reading section 20 contain specific patterns M. In short, since the relationship between the positions of the four dots m1 through m4 forming each specific pattern M is determined, the specific-pattern-detecting section 16 first detects the four dots m1 to m4, and identifying the relationship between the positions of the dots m1 to m4, detects whether the specific patterns M recorded by the image recording apparatus 10 are found. The CPU 11 is notified of the result of the detection by the specific-pattern-detecting section 16.

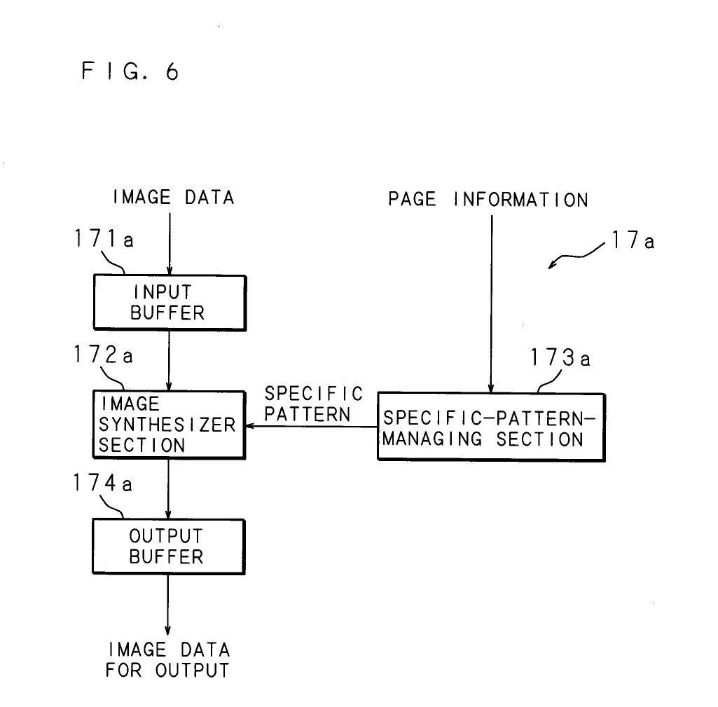

A specific-pattern-synthesis section 17a synthesizes specific patterns M for the image data transferred from the specific-pattern-detecting section 16. FIG. 6 is a block diagram showing the internal structure of the specific-pattern-synthesis section 17a. The specific-pattern-synthesis section 17a comprises an input buffer 171a which temporarily holds input image data, a specific-pattern-managing section 173a which stores the specific patterns M and calculates synthetic positions of the specific patterns M based on original reading conditions (which are conditions, such as the paper size, the paper orientation and the scale, hereinafter referred to as page information), an image synthesizer section 172a which synthesizes the specific patterns M output from the specific-pattern-managing section 173a for the image data which are held in the input buffer 171a, and an output buffer 174a which temporarily holds input image data synthesized by the image synthesizer section 172a. Reading the image data which are held in the output buffer 174a, the CPU 11 of the image recording apparatus 10 acquires synthesized image data.

Connected with the bus 12 via an interface circuit not shown, the image recording section 30 receives an instruction from the CPU 11 through the interface circuit and executes an image recording operation in accordance with the instruction. Further, the image recording section 30 sends various data to and receives various data from the other hardware sections via the interface circuit. In the event that an image needs be recorded on a sheet based on image data acquired by the image reading section 20, via the interface circuit, the CPU 11 provides the respective hardware sections with instructions demanding operations of the respective hardware sections inside the image recording section 30. Further, the image data from the image reading section 20 are transferred to the laser writing unit 330 via the interface circuit. The image recording section 30 makes the respective hardware sections operate in accordance with these instructions, whereby the image data are transferred to the laser writing unit 330, an electrostatic latent image is written on the photosensitive drum 331, thus written electrostatic latent image is visualized with toner which is supplied to the image, the toner image is transferred onto a sheet and the image is accordingly recorded.

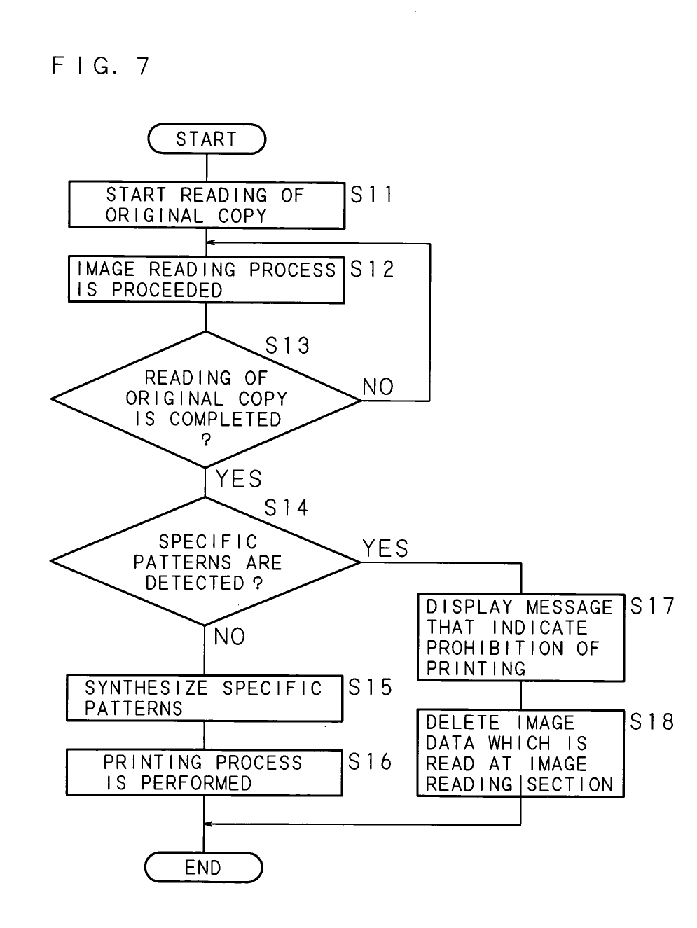

Operations of the image recording apparatus 10 will now be described. FIG. 7 is a flowchart for explaining a processing sequence which the image recording apparatus 10 follows in copying an original copy. When an instruction received on the operation panel 15 demands to start reading an original copy, the CPU 11 sends instructions to the light source unit 223 and the mirror unit 224 and reading of the original copy starts (Step S11). As the reading of the original copy starts, reading irradiation light is irradiated upon the original copy mounted on the document mounting 201 while the light source unit 223 and the mirror unit 224 move along the document mounting 201, so that the original copy is scanned and read (Step S12). Following this, the CPU 11 judges whether the reading of the original copy has completed (Step S13), and when determining that the reading of the original copy has not been completed (Step 13: NO), returns the processing back to Step S12.

When the judgment is that the reading of the original copy has completed (Step 13: YES), the image data acquired by the image reading section 20 are transferred to the specific-pattern-detecting section 16, and whether the image data contains specific patterns M is detected. The CPU 11 judges whether specific patterns M are detected, based on the result of the detection given by the specific-pattern-detecting section 16 (Step S14), and when determining that specific patterns M are not detected (S14: NO), transfers the image data acquired by the image reading section 20 to the specific-pattern-synthesis section 17a, and the specific-pattern-synthesis section 17a synthesizes specific patterns M for the image data (Step S15). The CPU 11 transfers the synthesized image data to the image recording section 30, and printing is performed during which the image recording section 30 records an image on a sheet (Step S16).

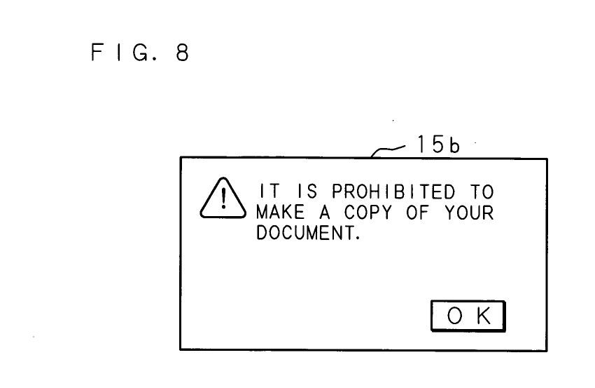

When the CPU 11 determines at Step S14 based on the result of the detection given by the specific-pattern-detecting section 16 that specific patterns M are detected (Step 14: YES), the display section 15b of the operation panel 15 displays a message which is indicative of prohibition of printing as shown in the schematic view in FIG. 8 (Step S17), and the image data read at Step S12 are deleted (Step S18).

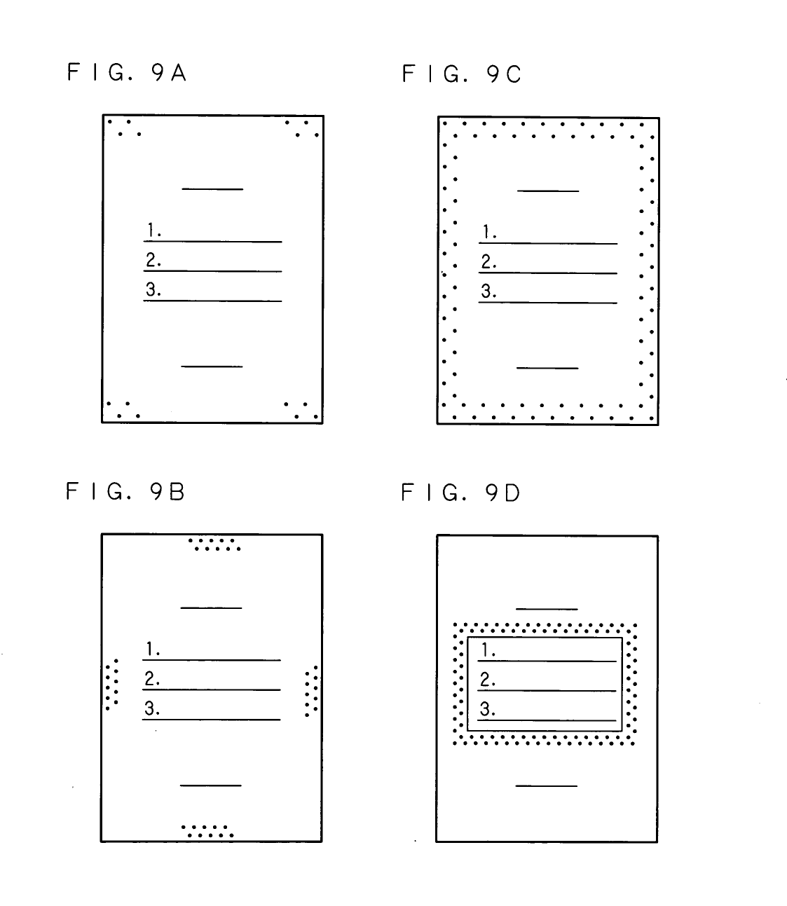

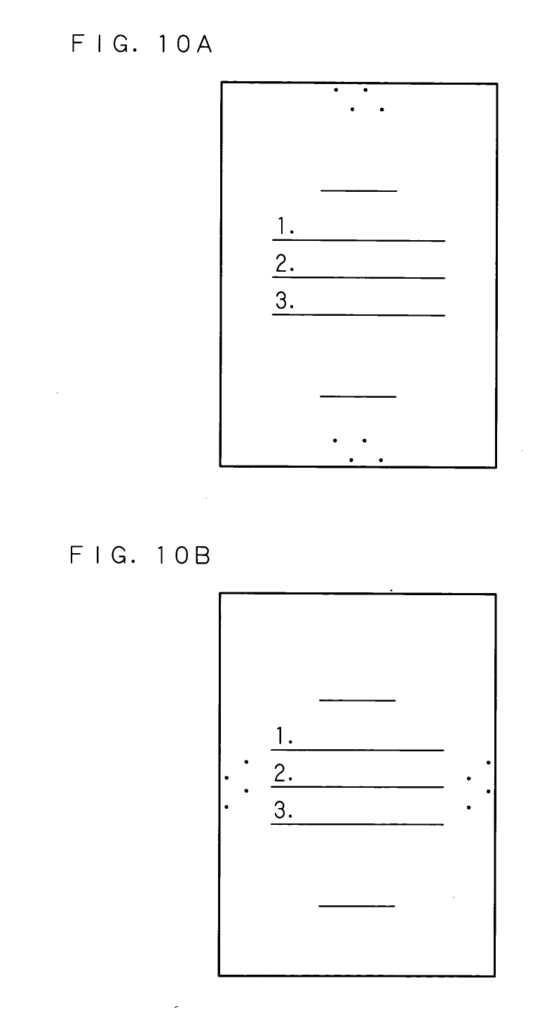

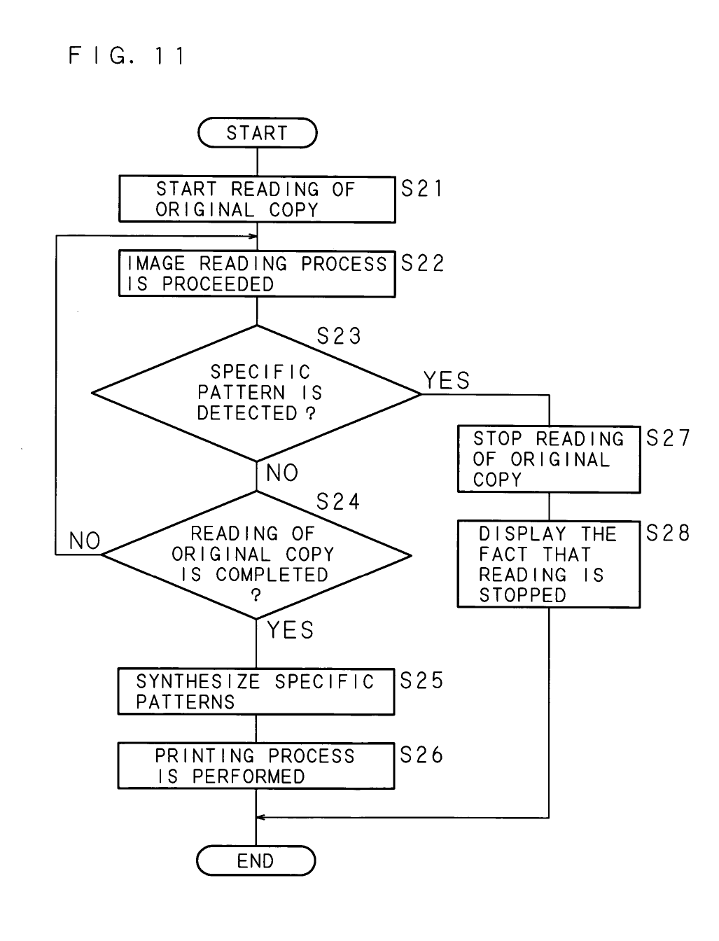

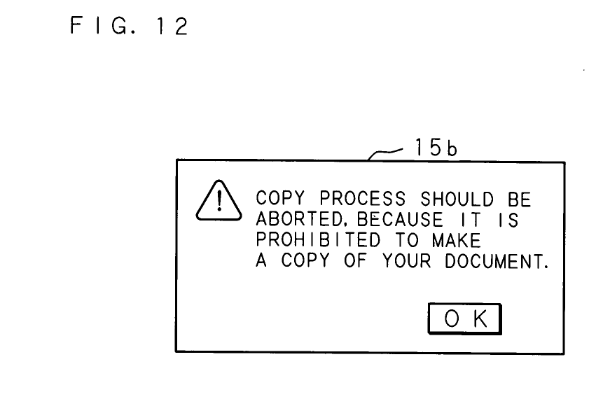

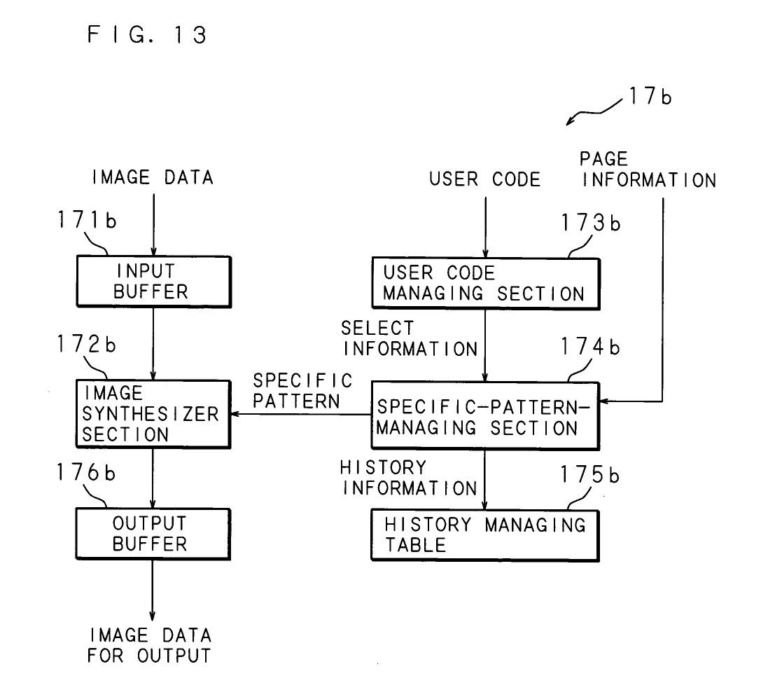

Although the embodiment above requires that the specific patterns M1 to M4 are recorded approximately at the center in the upper end section, the lower end section, the left end section and the right end section of a sheet, the recording style is not limited to that shown in FIG. 2. FIGS. 9A to 9D and FIGS. 10A and 10B are schematic diagrams showing other recording styles of specific patterns. In FIG. 9A, one specific pattern is recorded on each of the four corners of a sheet. In FIG. 9B, a specific pattern formed by ten dots are recorded. In FIG. 9C, a specific patter is recorded continuously in a peripheral section of a sheet. In FIG. 9D, a specific patter is recorded surrounding an original image right outside the original image. In FIG. 10A, there are specific patterns only in the upper end section and the lower end section of a sheet. In FIG. 10B, there are specific patterns only in the left end section and the right end section of a sheet. As shown in FIGS. 10A and is 10B, even without specific patterns provided on the four sides of a sheet, a similar effect to the effect described above is attained when it is possible for the reading apparatus to acquire the original image only along a predetermined direction of a sheet.

### SECOND EMBODIMENT

In the first embodiment directed to the structure in which whether specific patterns M are contained is detected after reading of an original copy has been completed and whether to permit copying is determined in accordance with the result of the detection, since the specific patterns M are located in peripheral sections of a sheet, it is possible to relatively quickly detect one of the specific patterns M regardless of the scanning direction of the original copy. Therefore, the reading of the original copy may be stopped upon detection of the specific pattern M while the original copy is being read. The structure of the image recording apparatus 10 according to this embodiment is identical to that according to the first embodiment, and hence, will not be described.

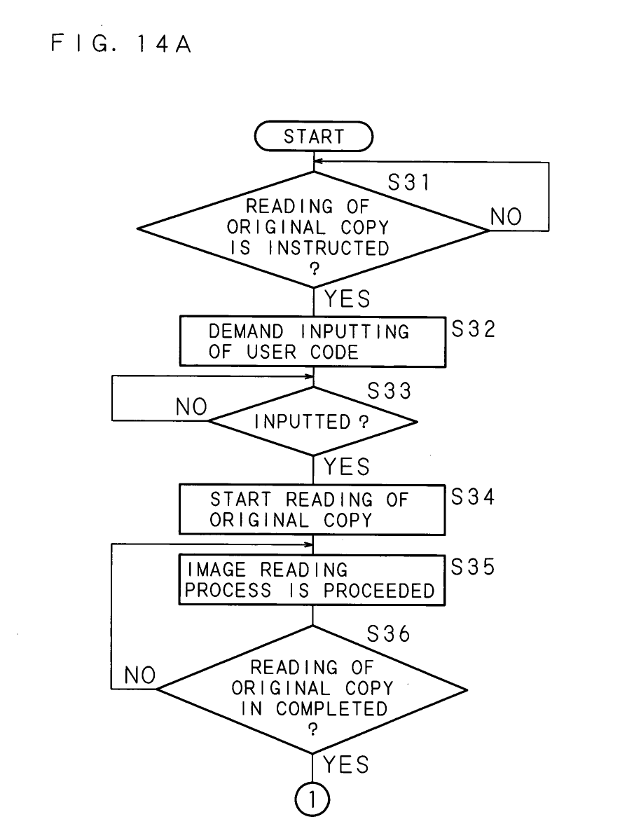

FIG. 11 is a flowchart for describing a processing sequence which the image recording apparatus follows in copying an original copy. When an instruction received on the operation panel 15 demands to start reading an original copy, the CPU 11 sends instructions to the light source unit 223 and the mirror unit 224 of the image reading section 20 and reading of the original copy starts (Step S21). As the reading of the original copy starts, reading irradiation light is irradiated upon the original copy mounted on the document mounting 201 while the light source unit 223 and the mirror unit 224 move along the document mounting 201, so that the original copy is read (Step S22).

Based on image data obtained through the reading (a part of image data in this embodiment), the specific-pattern-detecting section 16 detects whether a specific pattern M is contained. The CPU 11 then judges whether the specific pattern M is detected, based on the result of the detection given by the specific-pattern-detecting section 16 (Step S23). When determining that the specific pattern M is not detected (S23: NO), the CPU 11 judges whether the reading of the original copy has been completed (Step 24). When determining that the reading of the original copy has not been completed (Step 24: NO), the CPU 11 returns the processing back to Step S22, whereby reading of the original copy and detection of a specific pattern M continue.

When determining that the reading of the original copy has been completed without detecting any specific pattern M (Step S24: YES), the CPU 11 transfers the image data acquired by the image reading section 20 to the specific-pattern-synthesis section 17a, and the specific-pattern-synthesis section 17a synthesizes specific patterns M for the image data (Step S25). The CPU 11 transfers the synthesized image data to the image recording section 30, and printing is executed in which the image recording section 30 records an image on a sheet (Step S26).

On the contrary, when determining at Step S23 based on the result of the detection given by the specific-pattern-detecting section 16 that a specific pattern M is detected (Step S23: YES), the CPU 11 provides the light source unit 223 and the mirror unit 224 with a stop signal and accordingly stops the reading of the original copy (Step S27). At this stage, since the CPU 11 prohibits copying of the original copy as shown in the schematic view in FIG. 12, the display section 15b of the operation panel 15 displays a message which indicates that the reading is stopped (Step S28).

### THIRD EMBODIMENT

Although the embodiments above require that for copying of an original copy to which no specific pattern M has been added, one type of specific patterns M are synthesized for image data acquired by the image reading section 20 and printing is performed based on the synthesized image data, a code (hereinafter referred to as a user code) which specifies a user may be accepted and a specific pattern M prepared for each user in advance may be added for copying of an original copy.

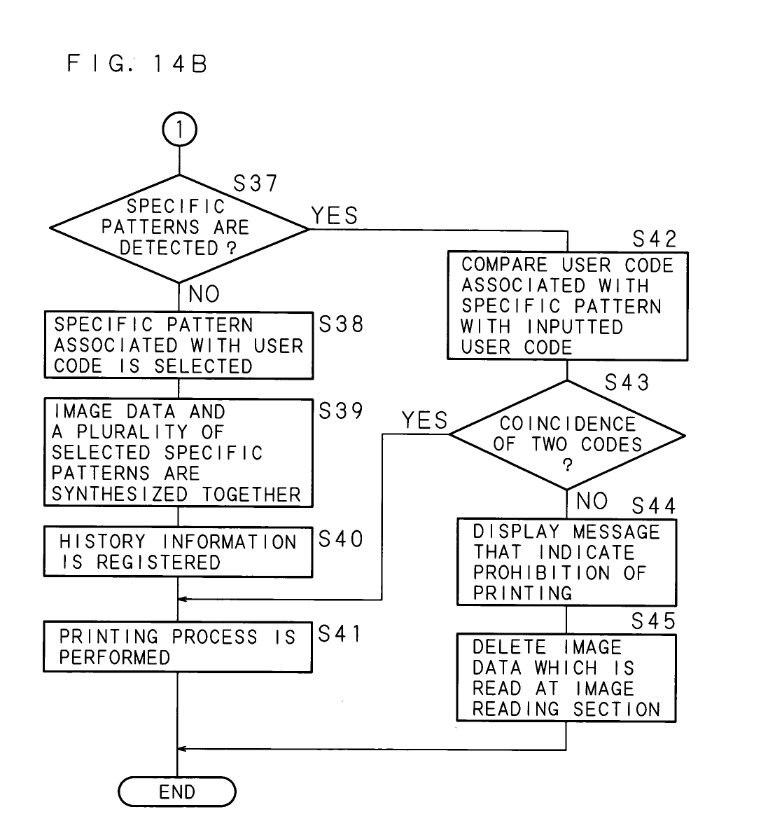

FIG. 13 is a block diagram showing the internal structure of a specific-pattern-synthesis section 17b according to this embodiment. The specific-pattern-synthesis section 17b according to this embodiment comprises an input buffer 171b which temporarily holds input image data, a user code managing section 173b which outputs select information with which a specific pattern is selected based on an input user code, a specific-pattern-managing section 174b which stores specific patterns and calculates the synthetic positions of the specific patterns based on original reading conditions (page information), a history managing table 175b which manages the history of synthesis of the specific patterns, an image synthesizer section 172b which synthesizes the specific patterns output from the specific-pattern-managing section 174b for the image data which are held in the input buffer 171b, and an output buffer 176b which temporarily holds input image data synthesized by the image synthesizer section 172b. Reading the image data which are held in the output buffer 176b, the CPU 11 of the image recording apparatus 10 acquires the synthesized image data.

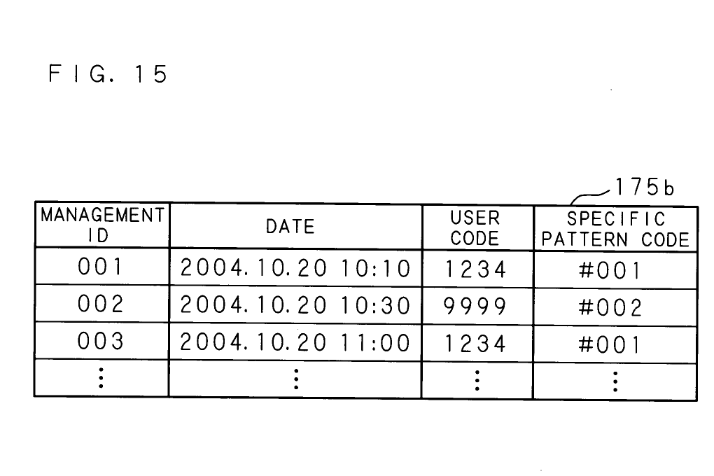

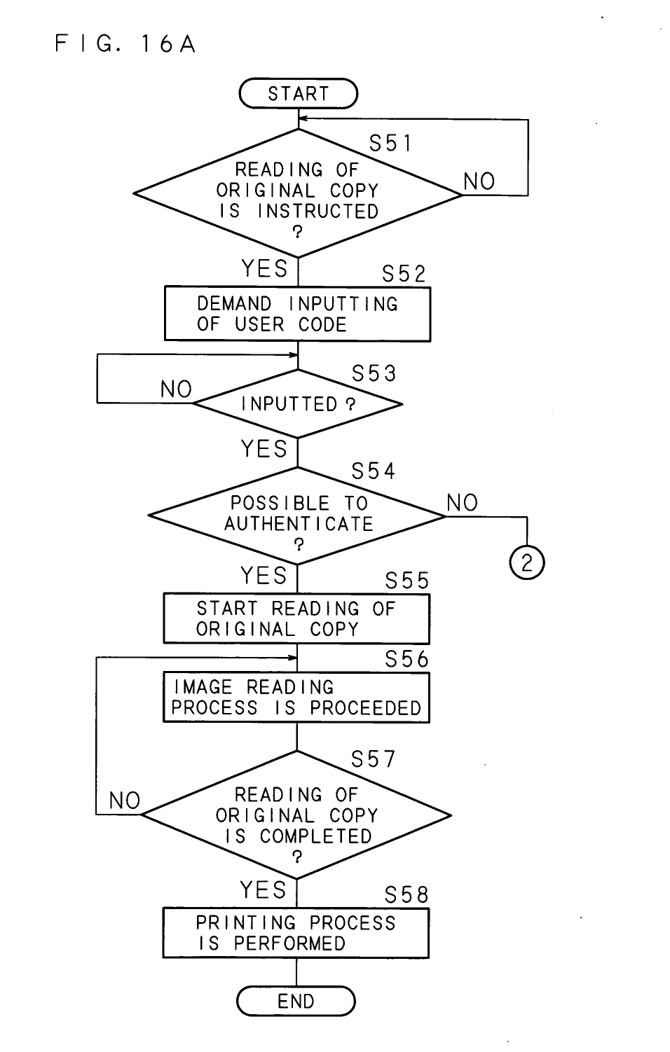

FIGS. 14A and 14B are flowcharts for describing a processing sequence which the image recording apparatus 10 follows in copying an original copy. First, the CPU 11 judges whether reading of an original copy has been instructed via the operation panel 15 (Step S31). When determining that the reading of the original copy has not been instructed (Step S31: NO), the CPU 11 waits for instruction to read the original copy.

When determining that the reading of the original copy is instructed via the operation panel 15 (Step S31: YES), the CPU 11 makes the display section 15b display a message that requests for an input and accordingly demands inputting of a user code (Step S32). The CPU 11 judges whether the user code has been inputted, and when determining that the user code has not been inputted (Step S33: NO), the CPU 11 waits for receipt of the user code.

When determining that the user code is inputted (Step S33: is YES), the CPU 11 sends instructions to the light source unit 223 and the mirror unit 224 of the image reading section 20 and reading of the original copy starts (Step S34). As the reading of the original copy starts, reading irradiation light is irradiated upon the original copy mounted on the document mounting 201 while the light source unit 223 and the mirror unit 224 move along the document mounting 201, so that the original copy is scanned and read (Step S35). The CPU 11 then determines whether the reading of the original copy has been completed (Step S36), and when determining that the reading of the original copy has not been completed (Step S36: NO), the CPU 11 returns the processing back to Step S35.

When determining that the reading of the original copy has been completed (Step S36: YES), the CPU 11 transfers the image data acquired by the image reading section 20 to the specific-pattern-detecting section 16, and whether the image data contain specific patterns M are detected. The CPU 11 judges whether specific patterns M are detected, based on the result of the detection given by the specific-pattern-detecting section 16 (Step S37).

When determining that specific patterns M are not detected (S37: NO), the CPU 11 transfers the input user code to the user code managing part which is disposed inside the specific-pattern-synthesis section 17b, so that specific pattern M associated with this user code are selected (Step S38). In other words, upon input of the user code, the user code managing section 173b outputs to the specific-pattern-managing section 174b select information which is for selecting a specific pattern M. A specific pattern M is selected based on the select information, thereby selecting a specific pattern M associated with this user code.

Thus selected specific pattern M is sent to the image synthesizer section 172b and the image data and a plurality of the selected specific patterns M are synthesized together (Step S39), and history information is registered in the history managing table 175b (Step S40). FIG. 15 is a conceptual diagram showing one example of the history managing table 175b. In the history managing table 175b, registrations are made correlating the date of synthesis of specific patterns, a user code accepted at that time and a code indicative of the specific pattern (specific pattern code) with a management ID which is a reference sign.

The CPU 11 then retrieves from the output buffer 176b the synthesized image data to be output, and transfers the image data to the image recording section 30 so that printing is performed (Step S41).

On the contrary, when determining at Step S37 that specific patterns M are detected (S37: YES), the CPU 11 compares the user code associated with the specific patterns M with the input user code (Step S42), and determines whether the two codes coincide with each other (Step S43). When determining that the two codes coincide with each other (Step S43: YES), the CPU 11 performs printing on the ground that a request for printing is given from a person authorized for printing (S41), but when determining that the two codes do not coincide with each other (Step S43: NO), the CPU 11 makes the display section 15b display a message indicative of prohibition of printing on the ground that a request for printing is given from a person unauthorized for printing (Step S44) and deletes the read image data (Step S45).

### FOURTH EMBODIMENT

Although the third embodiment is directed to a structure in which a code specifying a user (user code) is accepted at the time of copying of an original copy and specific patterns M prepared for each user are added, an alternative structure may be used instead which requires authentication of a user at the time of copying of an original copy and adds specific patterns M upon failure of authentication.

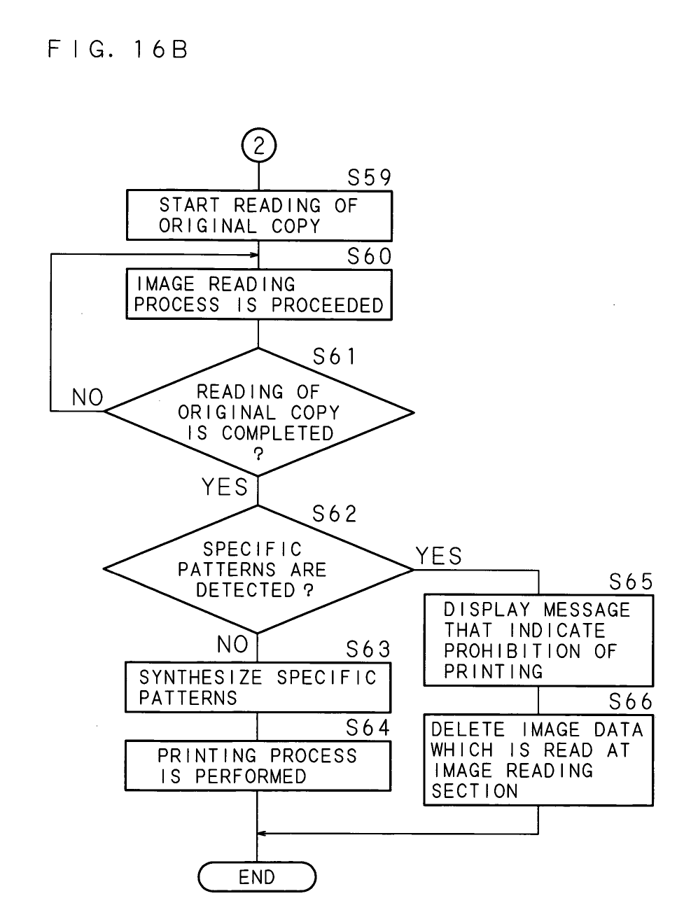

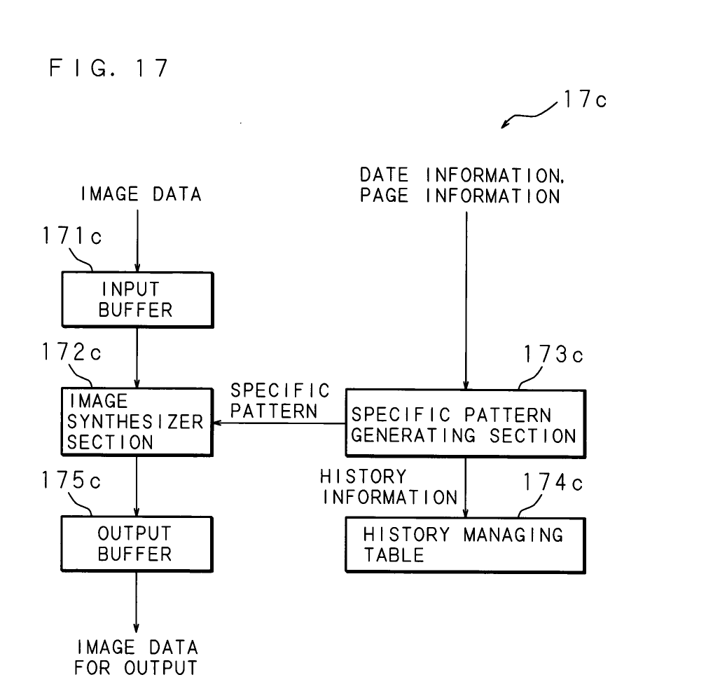

FIGS. 16A and 16B are flowcharts for describing a processing sequence which the image recording apparatus 10 follows in copying an original copy. First, the CPU 11 judges whether reading of an original copy has been instructed via the operation panel 15 (Step S51). When determining that the reading of the original copy has not been instructed (Step S51: NO), the CPU 11 waits for instruction to read the original copy.

When determining that the reading of the original copy is instructed via the operation panel 15 (Step S51: YES), the CPU 11 makes the display section 15b display a message which requests for an input and accordingly demands inputting of a user code (Step S52). The CPU 11 judges whether the user code has been inputted (Step S53), and when determining that the user code has not been inputted (Step S53: NO), the CPU 11 waits for an input of the user code.

When determining that the user code is inputted (Step S53: YES), the CPU 11 judges whether it is possible to authenticate a user based on the inputted user code (Step S54). When determining that it is possible to authenticate a user (Step S54: YES), the CPU 11 sends instructions to the light source unit 223 and the mirror unit 224 of the image reading section 20 and reading of the original copy starts (Step S55). As the reading of the original copy starts, reading irradiation light is irradiated upon the original copy mounted on the document mounting 201 while the light source unit 223 and the mirror unit 224 move along the document mounting 201, so that the original copy is scanned and read (Step S56). The CPU 11 then determines whether the reading of the original copy has been completed (Step S57), and when determining that the reading of the original copy has not been completed (Step S57: NO), the CPU 11 returns the processing to Step S56. When determining that the reading of the original copy has been completed (Step S57: YES), the CPU 11 transfers the image data acquired by the image reading section 20 to the image recording section 30 and performs printing (Step S58).

When determining at Step S54 that it is not possible to authenticate a user (Step S54: NO), reading of the original copy starts (Step S59), and reading is performed as the light source unit 223 and the mirror unit 224 scan the original copy (Step S60). The CPU 11 then determines whether the reading of the original copy has been completed (Step S61). When determining that the reading of the original copy has not been completed (Step S61: NO), the CPU 11 returns the processing back to Step S60.

When determining that the reading of the original copy has been completed (Step S61: YES), the CPU 11 determines whether specific patterns M are detected from the read image (Step S62). When determining that specific patterns M are not detected (Step S62: NO), specific patterns M are synthesized with the read image (Step S63), and the synthesized image data are transferred to the image recording section 30, whereby printing is performed (Step S64). When the CPU 11 determines that specific patterns M are detected (Step S62: YES), the display section 15b displays a message which is indicative of prohibition of printing (Step S65) and the read image data are deleted (Step S66).

### FIFTH EMBODIMENT

Although the embodiments above are directed to a structure which adds specific patterns M which have been prepared in advance (or one specific pattern selected from among plural specific patterns which have been prepared in advance), an alternative structure may be used instead which requires generating of a specific pattern based on information fed from the outside and adds the generated specific pattern. In relation to this embodiment, such a structure will now be described which generates a specific pattern based on date information output from a clock not shown.

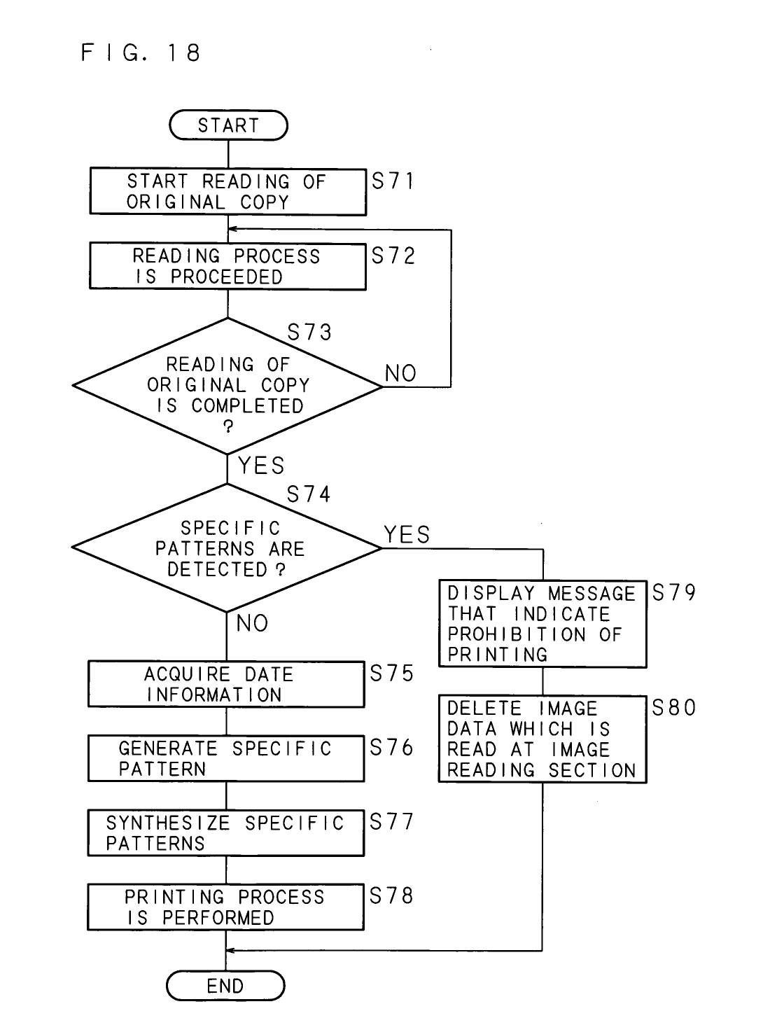

FIG. 17 is a block diagram showing the internal structure of a specific-pattern-synthesis section 17c according to this embodiment. The specific-pattern-synthesis section 17c according to this embodiment comprises an input buffer 171c which temporarily holds input image data, a specific pattern generating section 173c which generates a specific pattern based on inputted date information and calculates the synthetic position of the specific pattern based on original reading conditions (page information), a history managing table 174c which manages the history of synthesis of the specific pattern, an image synthesizer section 172c which synthesizes the specific pattern output from the specific pattern generating section 173c for the image data which are held in the input buffer 171c, and an output buffer 175c which temporarily holds input image data synthesized by the image synthesizer section 172c. Reading the image data which are held in the output buffer 175c, the CPU 11 of the image recording apparatus 10 acquires synthesized image data.

FIG. 18 is a flowchart for describing a processing sequence which the image recording apparatus 10 follows in copying an original copy. When an instruction received is given to on the operation panel 15 to start reading an original copy, the CPU 11 sends instructions to the light source unit 223 and the mirror unit 224 of the image reading section 20 and reading of the original copy starts (Step S71), and reading irradiation light is irradiated upon the original copy mounted on the document mounting 201 while the light source unit 223 and the mirror unit 224 move along the document mounting 201, whereby the original copy is scanned and read (Step S72).

Following this, the CPU 11 judges whether the reading of the original copy has been completed (Step S73), and when determining that the reading of the original copy has not completed (Step 73: NO), returns the processing back to Step S72. On the contrary, when determining that the reading of the original copy has been completed (Step S73: YES), the CPU 11 determines from the image thus read whether a specific pattern is detected (Step S74).

When determining that no specific pattern has been detected (S74: NO), the CPU 11 acquires date information from a clock not shown (Step S75), and transfers the acquired date information to the specific pattern generating section 173c, thereby generating a specific pattern (Step S76). The specific pattern generated by the specific pattern generating section 173c is synthesized with the read image data (Step S77), and printing is performed based on the synthesized image data (Step S78).

When it is determined that a specific pattern is detected (S74: YES), a message indicative of prohibition of printing is displayed (Step S79) and the read image data are deleted (Step S80).

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image recording apparatus, which accepts image data and records an image based on the accepted image data on a sheet, comprising:
a storage section for storing a predetermined pattern; and
a recording section for recording said pattern in plural numbers on the outside of a recording area for the image, when the image is to be recorded on a sheet.

2. An image recording apparatus, which accepts image data and records an image based on the accepted image data on a sheet, comprising:
a storage section for storing a plurality of types of pattern;
a controller capable of performing an operation of selecting a pattern to be recorded from among the patterns that are stored in the storage section; and
a recording section for recording the selected pattern in plural numbers on the outside of a recording area for the image, when the image is to be recorded on a sheet.

3. The image recording apparatus according to claim 2, comprising a storage section for storing information related to a user in association with each of the patterns,
wherein said controller is further capable of performing an operations of accepting information related a user when image data is accepted, and
selecting a pattern which is stored in association with the accepted information.

4. The image recording apparatus according to claim 1, further comprising a controller capable of performing operations of:
accepting information related to a user from the outside;
authenticating the user based on the accepted information; and
canceling recording of the patterns on a sheet when the user is authenticated.

5. The image recording apparatus according to claim 1, further comprising a controller capable of performing operations of:
accepting information from the outside;
generating a pattern based on the accepted information; and
recording the generated pattern in plural numbers together with the image on the sheet.

6. The image recording apparatus according to claim 1, wherein the pattern is formed by plural dots and a relationship between the positions of the dots is determined in advance.

7. The image recording apparatus according to claim 1, wherein the patterns are recorded on the sheet such that the patterns surround the image.

8. The image recording apparatus according to claim 1, wherein the sheet is rectangular and each of the patterns is recorded near each of the four sides or on each of the four corners of the sheet.

9. The image recording apparatus according to claim 1, further comprising:
an image reading section for reading an image recorded on a sheet; and
a controller capable of performing operations of:
detecting whether the image read by the image reading section includes the patterns; and
prohibiting recording of the image on the sheet when the patterns are detected in the image.

10. The image recording apparatus according to claim 1, further comprising:
an image reading section for reading an image recorded on a sheet; and
a controller capable of performing operations of:
detecting any one of the patterns while the image reading section reads the image; and
stopping reading of the image when the existence of the pattern is detected.

11. An image reading apparatus comprising:
an image reading section for reading an image that is recorded on a sheet by the image recording apparatus according to claim 1; and
a controller capable of performing operations of:
detecting the existence of a predetermined pattern while the image reading section reads the image; and
stopping reading of the image when the existence of the pattern is detected.

12. The image recording apparatus according to claim 1, wherein the storage section stores a plurality of types of pattern; and further comprising:
means for selecting a pattern to be recorded from among the patterns that are stored in the storage section, when the pattern is to be recorded in plural numbers on a sheet; and
means for recording the selected patterns in plural numbers together with the image on the sheet.

13. The image recording apparatus according to claim 12, further comprising:
means for storing information related to a user in association with each of the patterns;
means for accepting information related a user when image data is accepted; and
means for selecting a pattern which is stored in association with the accepted information.

14. The image recording apparatus according to claim 1, further comprising:
means for accepting information related to a user from the outside;
means for authenticating the user based on the accepted information; and
means for canceling recording of the patterns on a sheet when the user is authenticated.

15. The image recording apparatus according to claim 1, further comprising:
means for accepting information from the outside;
means for generating a pattern based on the accepted information; and
means for recording the generated pattern in plural numbers together with the image on a sheet.

16. The image recording apparatus according to claim 1, further comprising:
image reading means for reading an image recorded on a sheet;
means for detecting whether the image read by the image reading means includes the patterns; and
means for prohibiting recording of the image on a sheet when the patterns are detected in the image.

17. The image recording apparatus according to claim 1, further comprising:
image reading means for reading the image recorded on a sheet;
means for detecting any one of the patterns while the image reading means reads an image; and
means for stopping reading of the image when the existence of the pattern is detected.

18. An image reading apparatus comprising:
image reading means for reading an image that is recorded on a sheet by the image recording apparatus according to claim 1;
means for detecting the existence of the predetermined pattern while the image reading means reads an image; and
means for stopping reading of the image when the existence of the pattern is detected.
